(19) United States
(12) Patent Application Publication
(10) Pub. No.: US 2024/0335082 A1
(43) Pub. Date: Oct. 10, 2024

(54) DRAINING DIAGNOSTICS AUDIO FEEDBACK

(71) Applicant: Haier US Appliance Solutions, Inc., Wilmington, DE (US)

(72) Inventors: Ricardo Alberto Aguiar, JR., Clarksville, IN (US); Maegan Gail Williams, Louisville, KY (US)

(21) Appl. No.: 18/297,924

(22) Filed: Apr. 10, 2023

(51) Int. Cl. A47L 15/00; A47L 15/42; A47L 15/46; H04R 1/02; H04R 3/00; H04R 17/02

(52) U.S. Cl. CPC A47L 15/0049; A47L 15/0031; A47L 15/0063; A47L 15/4225; A47L 15/46; H04R 1/028; H04R 3/00; H04R 17/02; A47L 2401/06; A47L 2401/08; A47L 2401/32; A47L 2501/05

(57) ABSTRACT

A household dishwasher appliance includes a wash tub with a sump, an electrically powered pump in fluid communication with the sump, a piezo microphone mechanically coupled to a portion of the wash tub, and a controller operatively coupled to the electrically powered pump and the piezo microphone. The controller is configured to operate the electrically powered pump to drain wash fluid from the sump, receive an audio signal from the piezo microphone, and diagnose a clog condition of a drain hose by analyzing the audio signal.

### FIELD OF THE INVENTION

The present disclosure relates generally to diagnostics for household dishwashers, and more particularly to a diagnostic tool for drain failure faults.

### BACKGROUND OF THE INVENTION

Known household dishwasher appliances provide one or more streams of washing fluid (i.e., water, detergent, rinse aid, etc.) to remove food particles from articles placed within a wash tub in the dishwasher. The dishwasher may run through a number of cycles to complete the dishwashing operation. At various points during the dishwashing operation, a portion of the washing fluid collects in a sump and is removed from the wash tub to a waste via a pump. In some dishwashers, one or more filters are provided between the wash tub and the pump to prevent damage or obstruction of the pump components or clogging of the waste line.

In some instances, one or more of the filters may become clogged with food particles or the like and prevent a flow of washing fluid to the pump. In other instances, particles may become lodged in the waste hose creating a blockage in the waste line. In other instances, excess air in a waste line may lead to a failure to drain condition.

Some household dishwasher appliances monitor the pump to determine pump operating performance. For example, a sensor circuit may be provided to measure the current draw of the pump and compare the current draw to a predetermined value for a properly operating pump. If the pump is energized to pump washing fluid from the tub and the current draw is not as expected, a failure-to-drain error code may be generated indicating that the pump is not functioning properly and the wash cycle stopped. The variation in current draw can determine that the pump is not functioning properly to drain the washing fluid, but cannot determine the cause of the malfunction. Without further diagnostic capabilities on the dishwasher appliance, a potentially lengthy technician visit to diagnose and correct the fault is required, resulting in user dissatisfaction.

Accordingly, improvements in dishwasher fault diagnostics by the dishwasher appliance are desirable.

### BRIEF DESCRIPTION OF THE INVENTION

Aspects and advantages of the invention will be set forth in part in the following description, may be apparent from the description, or may be learned through practice of the invention.

In one exemplary aspect, a household dishwasher appliance comprising a wash tub including a sump, an electrically powered pump in fluid communication with the sump, a piezo microphone mechanically coupled to a portion of the wash tub, and a controller operatively coupled to the electrically powered pump and the piezo microphone is disclosed. The controller is configured to operate the electrically powered pump to drain wash fluid from the sump, receive an audio signal from the piezo microphone, and diagnose a clog condition of a drain hose by analyzing the audio signal.

In another exemplary aspect, a method of diagnosing a dishwasher drain fault is disclosed. The method comprises draining washing fluid from a dishwasher by energizing a pump motor and recording an audio signal while draining the wash fluid. The method compares the recorded audio signal to a predetermined audio signal and determines a clogged condition of a dishwasher waste line based on the comparison of the audio signals.

In another exemplary aspect, a method of operating a household dishwasher appliance comprising a wash tub including a sump, an electrically powered pump in fluid communication with the sump, a piezo microphone mechanically coupled to a portion of the wash tub is disclosed. The method comprises draining washing fluid from a dishwasher by energizing a pump motor, recording an audio signal of a portion of the dishwasher, comparing the audio signal with a predetermined audio signal, and determining a clogged condition of a dishwasher waste line based on the comparison of the audio signal. The step of determining a clogged condition of the dishwasher waste line comprises comparing the recorded audio signal to a first predetermined audio signal, wherein the dishwasher waste line is considered to be clogged if a recorded audio frequency domain is higher than a predetermined audio frequency domain value.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a dishwasher appliance in accordance with an embodiment of the present disclosure;

FIG. 2 provides a side partial sectional view of the dishwasher of FIG. 1;

FIG. 3 provides a current and audio signal plot of a normally operating dishwasher drain in accordance with an embodiment of the present disclosure;

FIG. 4 provides a current and audio signal plot of a clogged dishwasher drain in accordance with an embodiment of the present disclosure; and

FIG. 5 illustrates a method for diagnosing a dishwasher drain fault in accordance with an embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to, but need not be limited to dishes, pots, pans, silverware, and other cooking utensils and items that can be cleaned in a dishwashing appliance. The term “wash cycle” is intended to refer to one or more periods of time during which a dishwashing appliance operates while containing the articles to be washed and uses a detergent and water, preferably with agitation, to e.g., remove soil particles including food and other undesirable elements from the articles. The term “rinse cycle” is intended to refer to one or more periods of time during which the dishwashing appliance operates to remove residual soil, detergents, and other undesirable elements that were retained by the articles. Such may be after completion of the wash cycle or may be a cycle unto itself. The term “drain cycle” is intended to refer to one or more periods of time during which the dishwashing appliance operates to discharge soiled water from the dishwashing appliance. The term “cleaning cycle” is intended to refer to one or more periods of time that may include a wash cycle, rinse cycle, or a drain cycle. The term “wash fluid” refers to a liquid used for washing or rinsing the articles and is typically made up of water that may include other additives such as detergent or other treatments. The term “rinse fluid” refers to a fluid used for rinsing the articles and is typically made up of water and may include other additives such as rinse aid solutions. The term “wash” is intended to refer or reference the fluid or process of adding detergent to water to remove dirt and particles from articles to be washed. The term “rinse” is intended to refer or reference the fluid or process of using water and potentially rinse aid additives to remove residual soil, detergents, or other undesirable elements that were retained by the articles.

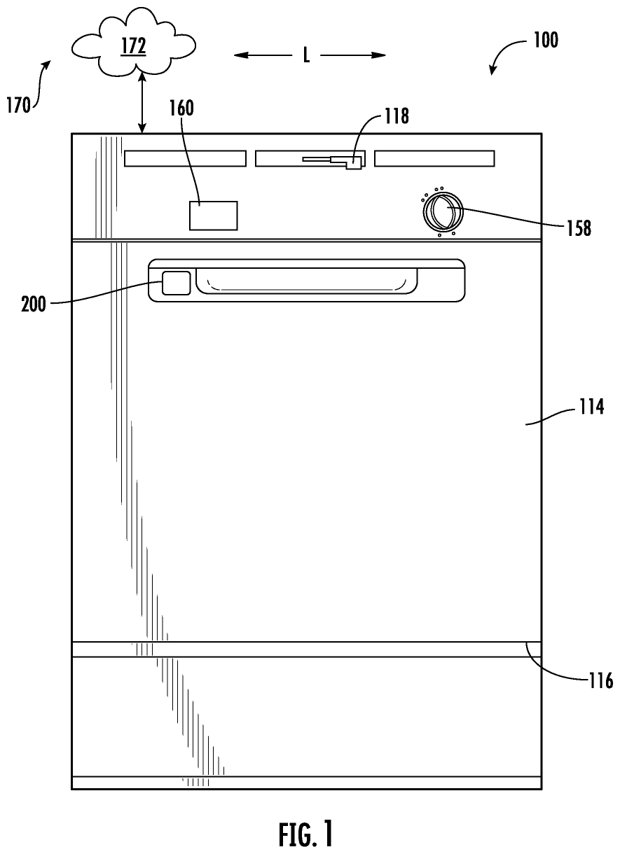

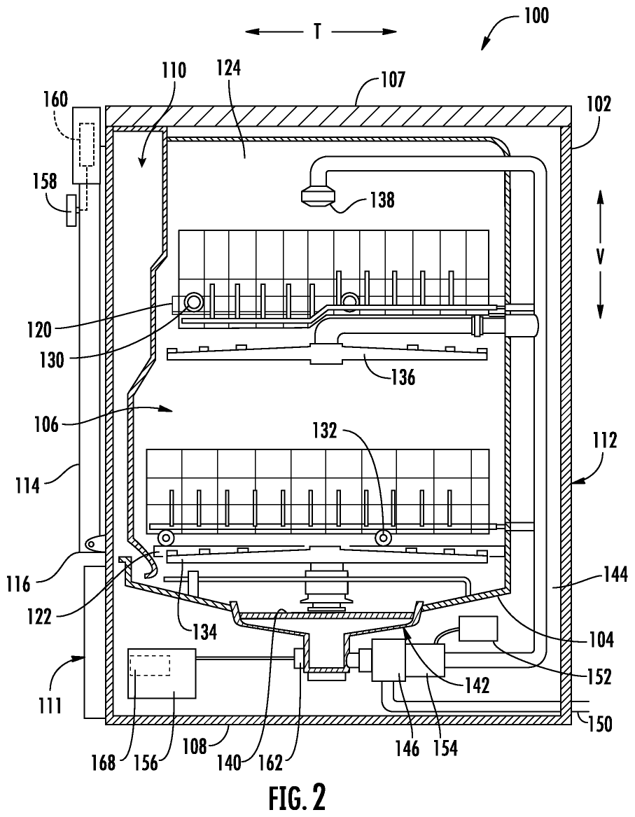

FIGS. 1 and 2 depict an exemplary domestic dishwasher or dishwashing appliance 100 that may be configured in accordance with aspects of the present disclosure. FIG. 1 is a front view of a dishwasher appliance 100 with the door in a closed position and FIG. 2 is a side sectional view of the dishwasher appliance 100 of FIG. 1. For the particular embodiment of FIGS. 1 and 2, the dishwasher appliance 100 includes a cabinet 102 (FIG. 2) having a tub 104 therein that defines an interior wash chamber 106. As shown in FIG. 2, tub 104 extends between a top 107 and a bottom 108 along a vertical direction V, between a pair of opposing side walls 110 along a lateral direction L, and between a front side 111 and a rear side 112 along a transverse direction T. Each of the vertical direction V, lateral direction L and transverse direction T are mutually perpendicular to one another. References to these orthogonal directions when specifically describing door 114 are based on door 114 being in a closed position as shown in FIGS. 1 and 2 unless clearly indicated otherwise.

In this regard, as used herein, the terms “cabinet,” “housing,” and the like are generally intended to refer to an outer frame or support structure for appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of appliance 100. By contrast, cabinet 102 may enclose some or all interior portions. It should be appreciated that cabinet 102 may have any suitable size, shape, and configuration while remaining within the scope of the present subject matter.

The tub 104 includes a front cabinet opening (not shown) and a door 114 horizontally hinged (i.e., axis of rotation is parallel to the lateral direction) at its bottom 116 for movement between a normally closed vertical position (shown in FIGS. 1 and 2), wherein the wash chamber 106 is sealed shut for washing operations, and a substantially horizontal open position for loading and unloading of articles from the dishwasher 100 (not shown). Door 114 is mounted on cabinet 102 to selectively restrict access to the internal chamber (e.g., wash chamber 106) in the closed position. Door 114 includes a handle, for example a pocket handle 200, mounted thereto (FIG. 1). Latch 118 is used to lock and unlock door 114 for access to wash chamber 106. A vertically lower portion of the tub 104 includes a sump 142. As the lower portion of the tub 104, the sump 142 may collect the washing fluid by gravity and provide the washing fluid to pump 146. The sump 142 may be formed with the tub 104 or may be formed as a separate piece and coupled in a fluid-tight manner to a bottom portion of the tub 104.

At least one rack assembly is slidably positioned within wash chamber 106 and is configured for the receipt of articles for cleaning. For the exemplary embodiment shown in FIG. 2, opposing tub side walls 110 accommodate a plurality of rack assemblies 126, 128. More specifically, upper and lower guide rails 120, 122 are mounted on tub side walls 124 and accommodate roller-equipped rack assemblies 126 and 128. Each rack assembly 126, 128 is adapted for movement between an extended loading position (not shown), in which the rack 126 or 128 is substantially positioned outside the wash chamber 106, and a retracted position (shown in FIGS. 1 and 2), in which the rack 126 or 128 is located inside the wash chamber 106. This rack movement is facilitated by rollers 130 and 132, for example, mounted onto racks 126 and 128, respectively. Although guide rails 120, 122 and rollers 130, 132 are illustrated herein as facilitating movement of the respective rack assemblies 126, 128, it should be appreciated that any suitable sliding mechanism or member(s) may be used according to alternative embodiments. In some embodiments, dishwasher appliance 100 may accommodate a different number of rack assemblies and supporting guide rails. For example, dishwasher appliance 100 may accommodate only first rack assembly 126 with accompanying guide rails. In another example, dishwasher appliance 100 may accommodate a third rack assembly (not pictured) with accompanying guide rails. The third rack assembly may be located vertically above rack assemblies 126, 128.

For the exemplary embodiment of FIG. 2, dishwasher appliance 100 includes a plurality of spray assemblies 134, 136, 138 for urging a flow of water or wash fluid onto the articles placed within wash chamber 106. More or fewer spray arm assemblies may be provided in the wash chamber 106. The spray-arm assemblies 134, 136, 138 may be part of a fluid circulation assembly 144 for circulating water and dishwasher fluid in the tub 104. The fluid circulation assembly 144 may also include a pump 146 positioned in a machinery compartment 148 located below the tub sump 142 of the tub 104. In some embodiments, the pump 146 may be located in the sump 142. Pump 146 may receive fluid from sump 142 to provide a flow of wash fluid to fluid circulation assembly 144, or optionally, a switching valve or diverter (not shown) may be used to direct the flow of wash fluid to waste line 150. At various points in a wash cycle, the pump 146 may drain some, or all, or substantially all, of the fluid from the tub 104. For example, the wash cycle may transition from a washing operation to a rinsing operation and require the used wash fluid to be removed and replaced with fresh rinse fluid. Alternately, at the end of a washing cycle, all of the fluid may be removed from the tub as part of a drying process for the washed articles.

One or more filters 140 may be disposed vertically above the sump 142 to prevent large particles or other material from the washing fluid from entering the sump 142 and the pump 146. The filters 140 may sealingly engaged with the sump to prevent a flow of washing fluid from circumventing the filters 140. Typically pump 146 is driven by an electrically powered motor 154. An electrical sensing circuit 152 may be operatively coupled to the pump 146 and controller 156 and configured to measure an electrical draw of the pump 146 during pumping operations. For example, the electrical sensing circuit 152 may include, at least, an ammeter, or equivalent circuit, to detect the electrical current draw of the pump 146 or detect a signal indicative of the current drawn.

The dishwasher appliance 100 may include a controller 156 that may be generally configured to facilitate the appliance operation. The controller may be in operative communication with one or more user input devices 158, such as one or more of a variety of digital, analog, electrical, mechanical, or electro-mechanical input devices including rotary dials, control knobs, push buttons, toggle switches, selector switches, and touch pads. The controller 156 may include one or more processors, for example first processor 168, to analyze input signals, process the received data, and direct operations or functions of the dishwasher appliance 100. The controller 156 may be in operative communication with the sensing circuit 152 to receive input signals from the sensing circuit 152 related to the functioning of the motor 154 and pump 146, process the signals in the first processor 168 and modify the function of the dishwasher appliance 100 or signal fault messages to display on the appliance or send appropriate signals or messages to an external network (to be more fully described below).

Additionally, appliance 100 may include a display 160, such as a digital or analog display device generally configured to provide visual feedback regarding the operation of appliance 100. For example, display 160 may include one or more status lights, screens, or visible indicators. The display may be in operative communication with the controller 156 to display operating conditions of various components of the dishwashing appliance 100, for example the functioning of the pump 146 and motor 154. According to exemplary embodiments, user input devices 158 and display 160 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

A large number of minor faults may be detected by the controller 156 and displayed on the display 160 for general information to the user or for correction by a user while the dishwasher appliance continues to operate. Some faults, for example a failure to drain fault, are considered critical faults and may warrant cancelling of the washing cycle and disabling of the appliance until the fault is corrected.

Some appliances may include an external communication system 170 configured for permitting interaction, data transfer, and other communications between dishwasher appliance 100 and one or more external devices or networks 172. External communication system 170 may communicatively link the controller 156 of the dishwasher appliance to an external network under the monitoring or control of the manufacturer of the appliance or a service technician associated with the manufacturer. For example, this communication system 170 may be used to report minor operating faults to a manufacturer's network 172 to direct incremental improvements in performance of the dishwasher appliance 100. During normal operation of the dishwashing appliance 100, the external communication system 172 may periodically communicate operating parameters of the dishwashing appliance 100 to the network. For example, the network 172 may receive audio signals 178, 182 from the piezo microphone 162 and determine operating efficiencies of the dishwasher appliance 100. In the event of a critical fault (i.e., a fault sufficiently severe or dangerous that the dishwashing appliance must be shut down), the external communication system 170 may alert a repair technician of the occurrence of the fault to prepare for a service call. The more information the technician has regarding the nature of the fault, the better prepared the technician may be to correct the fault in a timely manner and positively influence the customer's experience.

For example, when the on-board sensors in a known dishwasher rely on current draw to detect a failure to drain fault, a critical fault. A failure to drain fault could result from a number of causes, each requiring different diagnostic procedures and potential replacement parts. Eliminating some of the potential causes of the fault can assist the technician in locating and correcting the fault in a timely manner. Current on-board failure to drain fault detection systems sense a current reading from the sensing circuit 152 at the pump motor 154 indicating a higher than normal current draw by the pump motor 154. Similar data may be indicative of numerous causes of a failure to drain fault. For example, a clogged filter 140, and obstructed or clogged pump 146, or a clogged waste line 150 may provide similar symptoms.

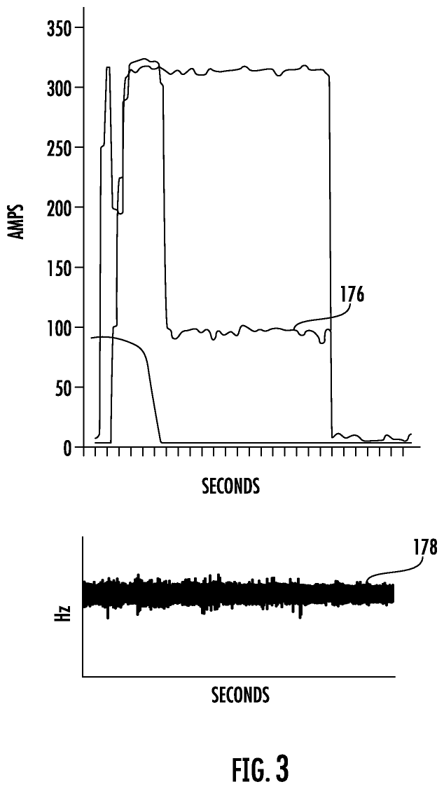

In accordance with the present disclosure, a vibration sensor, for example a piezo microphone 162 mounted to the sump 142 and operatively coupled to the controller 156 (FIG. 2), is configured to detect vibrations from the pump 146 and motor 154 during operation (i.e., when energized as controlled by the controller 156). During normal operation with no obstructions to the filter(s) 140, pump 146, or waste line 150, the motor 154 draws a generally consistent current 176 and displays a distinctive audio signature 178 as illustrated in FIG. 3. During manufacture and test, or during actual run-time by the user, the unobstructed or “healthy drain” current draw 176 can be detected by the sensing circuit 152 and saved to the controller 156. Similarly, the unobstructed or “healthy drain” audio signature 178 can be recorded by the piezo microphone 162 and also stored at the controller 156.

Under normal operating conditions (i.e., a healthy drain) the piezo microphone 162 and sensing circuit 152 may operate to receive and record data internally on a continuous basis during operation of the motor 154 and pump 148. In some instances, the recorded data may be transmitted periodically via external communication system 170 to a network 172 for statistical analysis purposes, remote monitoring, or the like. During operation, the received and recorded data is internally processed at the controller 156 to evaluate the performance of the dishwasher appliance 100. The received data may be compared to previously recorded and saved data corresponding to normal dishwasher operations to determine the presence of any faults in the operation. Normal operating conditions and minor faults may be recorded and periodically communicated to the network 172 as part of the normal data gathering process. Critical faults, such as a failure to drain fault, require immediate attention.

Upon detecting an unusual current draw from the sensing circuit 152, controller 156 communicates prompt instructions via signals to the various appliance components. Initially the user is alerted to the fault at least through the display 160 on the dishwasher appliance 100. Simultaneously, or sequentially, the network 172 is informed of the fault which may generate an alert to a service center local to the faulty appliance. In accordance with this disclosure, the failure to drain fault, initially triggered by a current anomaly, is further analyzed in the controller 156. In particular, the audio signal 182 is recorded at the controller 156 at the time corresponding to the detected fault, as indicated by an unusual current draw, and is processed to compare it with the known audio signal of a clogged waste line 150. In instances when the recorded audio signal corresponds with the predetermined signal for a clogged waste line 182, there is a high probability that an obstructed waste line 150 has caused the fault.

Through experiment and analysis, it has been demonstrated that a clogged or blocked waste line 150 generates a distinctive audio signature or signal 182 regardless of the cause of the blockage. Foreign objects, such as food particles, collected in the waste line 150 produce a signature similar to an airlock in the waste line 150, a pinched waste line 150, or a blocked inlet or outlet of the waste line 150. Controller 156 can use the failure to drain current signal 180 with the audio signal indicative of a clogged waste line 182 to facilitate determination of the cause of the critical fault.

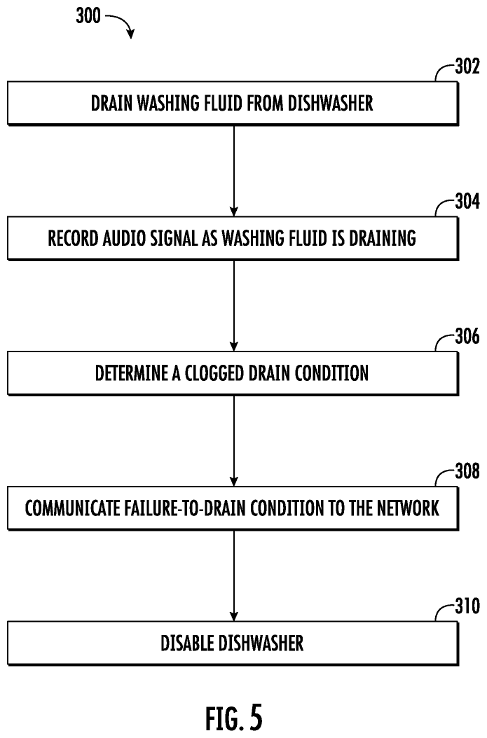

Now that the construction of a household dishwashing appliance in accordance with the present disclosure has been presented, an exemplary method 300 of operation will be described with reference to FIG. 5. Method 300 begins at 302 with the draining of washing fluid from the tub of a household dishwasher 100. The dishwasher 100 may operate as directed by the controller 156 through a series of wash, rinse, and dry cycles. At the end of some of the cycles, the controller 156 sends a signal to energize the pump motor 154 to operate the pump 146, creating a flow of washing fluid out of the tub, generally through the sump 142, to waste line 150.

At 304, as the washing fluid is being removed from the sump by the pump 146 and motor 154, a vibration sensor, for example a piezo microphone 162, detects the vibration caused by the pump/motor 146/154 combination. Periodically this information is sent to the network 172 through the external communication system 170. During normal or “healthy drain” operating conditions as predetermined or learned during normal operation, the audio signal detected by the piezo microphone 162 falls within normal limits in the frequency domain (y-axis) as illustrate in FIG. 3. This normal, or predetermined, domain may be stored in the controller 156. As the controller 156 receives the signals from piezo microphone 162, the incoming audio signal is compared to the predetermined, or “healthy drain” audio domain signal 178 to check for anomalies that might indicate a drain problem, such as a failure to drain.

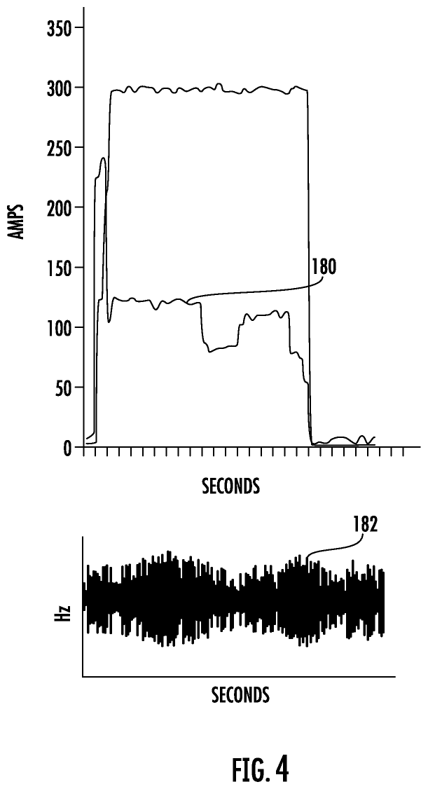

At 306, a clogged drain condition may be detected if a recorded audio signal has a higher frequency domain, as illustrated for example at 178 in FIG. 4. The controller determines a “healthy drain” or clogged drain by comparing the frequency domain of the recorded audio signal with the predetermined audio signal. If the frequency domain exceeds a preestablished difference, the controller 156 determines a clogged waste line 150 and signals a critical fault. The critical fault can be communicated to the network 172 through the external communication system 170.

At 310, as a safety precaution, the network 170 can communicate back to the controller 156 that a critical fault has been detected (i.e., a failure to drain fault) and further operation of the dishwasher 100 without correction of the fault could be dangerous. The network 172 via the external communication system 170 would then disable further functioning of the dishwasher until proper service is performed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A household dishwasher appliance comprising:
a wash tub including a sump;
an electrically powered pump in fluid communication with the sump;
a piezo microphone mechanically coupled to a portion of the wash tub; and
a controller operatively coupled to the electrically powered pump and the piezo microphone, the controller being configured to:
operate the electrically powered pump to drain wash fluid from the sump;
receive an audio signal from the piezo microphone; and
diagnose a clog condition of a drain hose by analyzing the audio signal.

2. The household dishwasher appliance of claim 1, further comprising an electronic sensing circuit operatively coupled to the pump and the controller.

3. The household dishwasher appliance of claim 2, wherein the electronic sensing circuit includes at least an ammeter, the ammeter operative to communicate a current draw of the pump to the controller.

4. The household dishwasher appliance of claim 3, wherein the controller compares the audio signal from the piezo microphone to a predetermined audio signal and compares the current draw of the pump to a predetermined current draw value.

5. The household dishwasher appliance of claim 4, further comprising an external communication system in operative communication with a network.

6. The household dishwasher appliance of claim 5, wherein the external communication system periodically communicates a portion of the audio signal and a corresponding current draw of the pump to the network for processing.

7. The household dishwasher appliance of claim 6, wherein the network stores the audio signal and the current draw in a memory location and compares the audio signal to a predetermined audio signal and compares the current draw to a predetermined current draw to determine an operating efficiency of the household dishwasher appliance.

8. The household dishwasher appliance of claim 1, wherein the piezo microphone is mechanically coupled to the sump.

9. The household dishwasher appliance of claim 8, wherein the audio signal corresponds to an operation of the pump.

10. A method of diagnosing a dishwasher drain fault, comprising the steps of:
draining washing fluid from a dishwasher by energizing a pump motor;
recording an audio signal while draining the wash fluid;
comparing the recorded audio signal to a predetermined audio signal; and
determining a clogged condition of a dishwasher waste line based on the comparison of the audio signals.

11. The method of claim 10, wherein the step of determining a clogged condition of the dishwasher waste line comprises comparing the recorded audio signal to a predetermined audio signal, wherein a recorded audio frequency domain higher than a predetermined audio frequency domain value indicates the dishwasher waste line is clogged.

12. The method of claim 11, further comprising measuring a current draw of the pump motor.

13. The method of claim 12, wherein determining the clogged condition further comprises comparing the measured current draw of the pump motor with a predetermined current draw value and comparing the recorded audio signal to a first predetermined audio signal, wherein the dishwasher waste line is considered to be clogged if the recorded audio frequency domain is higher than the predetermined audio frequency domain value and the measured current draw is lower that the predetermine current draw.

14. The method of claim 11, wherein the audio signal is recorded at a portion of a wash tub of the dishwasher.

15. The method of claim 14, wherein the portion of the wash tub is a sump.

16. The method of claim 11, wherein the predetermined audio signal corresponds with a properly draining dishwasher drain line.

17. A method of operating a household dishwasher appliance comprising a wash tub including a sump, an electrically powered pump in fluid communication with the sump, a piezo microphone mechanically coupled to a portion of the wash tub, the method comprising:
draining washing fluid from a dishwasher by energizing a pump motor;
recording an audio signal of a portion of the dishwasher;
comparing the audio signal with a predetermined audio signal;
determining a clogged condition of a dishwasher waste line based on the comparison of the audio signals; and
wherein the step of determining a clogged condition of the dishwasher waste line comprises comparing the recorded audio signal to a first predetermined audio signal, wherein the dishwasher waste line is considered to be clogged if a recorded audio frequency domain is higher than a predetermined audio frequency domain value.

18. The method of claim 17, further comprising measuring a current draw of the pump motor.

19. The method of claim 18, wherein determining the clogged condition further comprises comparing the measured current draw of the pump motor with a predetermined current draw value and comparing the recorded audio signal to a first predetermined audio signal, wherein the dishwasher waste line is considered to be clogged if the recorded audio frequency domain is higher than the predetermined audio frequency domain value and the measured current draw is lower that the predetermine current draw.

20. The method of claim 17, wherein the audio signal is recorded at the sump of the wash tub.
